(19) United States
(12) Patent Application Publication
(10) Pub. No.: US 2025/0099210 A1
(43) Pub. Date: Mar. 27, 2025

(54) CONSULTATION METHOD AND DATA COLLECTION KIT THEREFOR

(71) Applicant: Catherine Ashley Muldoon, Dobbs Ferry, NY (US)

(72) Inventor: Catherine Ashley Muldoon, Dobbs Ferry, NY (US)

(21) Appl. No.: 18/472,713

(22) Filed: Sep. 22, 2023

(51) Int. Cl. A61C 9/00

(52) U.S. Cl. CPC A61C 9/0006; A61C 9/0053

(57) ABSTRACT

A remote dental impressions kit includes an impression material, one or more impression trays, and a way to transmit a patient-produced dental impression to a dental provider. The kit makes dental care more efficient for the patient and provider. A method of remote initial dental treatment includes obtaining a still photographic image of a patient remotely from the patient; determining patient suitability for remote treatment; providing the kit to the patient; obtaining the patient-produced dental impression remotely from the patient; determining a preferred method of treatment from remote communication with the patient; and obtaining or producing a dental treatment prepared from the patient-produced dental impression. The dentist can prepare a 3-dimensional print of the patient's teeth by milling or stereolithography to guide the care provided. The kit helps visualize the proposed treatment(s) for the patient during initial consult visits, communicate to lab, and serve as a “prep guide”.

### BACKGROUND OF THE INVENTION

The present invention relates to cosmetic dentistry devices and methods and, more particularly, to an impression kit that enables remote consultation between dentist and patient. Moreover, the present invention relates to a method for consulting about comprehensive dentistry to execute a treatment plan.

For a patient to obtain aesthetic dental treatment or orthodontic devices, the patient must consult with a dentist or orthodontist. A traditional dental consultation is time consuming and requires a patient to go to an office. It also doesn't allow for visual communication so the patient can see and try proposed outcomes. Some companies have proposals for aligners but not veneers or both. At the time of writing, a coronavirus disease 2019 (COVID-19) pandemic has caused most dental offices to close in order to slow the spread of the novel coronavirus, making a traditional dental consultation difficult if not impossible to obtain. Some companies offer aligners “direct to consumer” but do not offer full service dental design and comprehensive patient care. While some over-the-counter (OTC) companies use devices to capture dental impression data, the existing devices don't use a low viscosity vinyl polysiloxane referred to as “light body”. In addition, existing devices and services don't incorporate facial scans or photos into the dental design.

As can be seen, there is a need for a product that allows a dentist to, at least initially, remotely and in person consult with a patient while still offering a full variety of treatment options and showing outcomes that are BOTH orthodontic AND restorative.

### SUMMARY OF THE INVENTION

In one aspect of the present invention, a remote dental impressions kit comprises an impression material, one or more impression trays, and an impression transmitting means operative to transmit a patient-produced dental impression to the provider or a scanner. Scanners currently don't incorporate a facial scan with the infraoral scan.

In another aspect of the present invention, a method of remote initial dental treatment comprises obtaining a still photographic image of a patient remotely from the patient; determining patient suitability for remote treatment; providing the kit to the patient; obtaining the patient-produced, dentist-produced, or concierge/dental assistant-produced dental impression remotely from the patient; determining a preferred method of treatment from remote communication with the patient; and obtaining or producing a dental treatment prepared from the produced dental impression.

My kit, device, and process allow people to see a dentist virtually and allow remote treatment for all cosmetic options, eliminating initial consultation visits for creating dental designs. The impression kit allows a patient to take an impression of his or her own teeth so that the dentist or other oral health professional may consult with the patient remotely about treatment and may design any dental device before the patient enters a dental office. The inventive kit may be used to make impression of any object, including any portion of the body. The impression may be scanned using a 3-dimensional (3D) scanner, so that the impression may be 3D printed and/or so that modifications may be designed offsite. 3D prints of dental veneers, templates for dental veneers, crowns, bridges, or anything that has a 3-dimensional shape may be prepared using the inventive kit.

The inventive process provides more efficient care for the patient and provider. A patient may virtually visit a dental office. A dentist may prepare a 3-dimensional print of the patient's teeth by milling or by stereolithography or 3D printing to guide the care he or she provides. A lab may streamline communication with the patient and/or the dentist, the lab fabricating the prosthetics, and specialists.

These and other features, aspects and advantages of the present invention will become better understood with reference to the following drawings, description, and claims.

### BRIEF DESCRIPTION OF THE DRAWINGS

FIG. 1 is a flow chart of a process according to an embodiment of the present invention;

FIG. 2 is a flow chart of a process according to another embodiment of the present invention; and

FIG. 3 is a schematic view of a kit according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “light body” refers to low viscosity vinyl polysiloxane.

Broadly, one embodiment of the present invention is a remote dental impression kit for collection of dental impressions remote from a dentist's office, a device for use therewith, and a method of treating dental patients remotely (and in person).

The kit may comprise an impression material or materials, one or more impression trays, and a transmitting means of transmitting the impression to the provider. The transmitting means may be a standard physical shipping method or an electronic scanning device.

Any suitable dental impression material may be used, including any combination of materials selected from the group consisting of rigid impression materials and impression waxes. Rigid impression materials include, for example, polyvinyl siloxane (PVS) impression materials, impression plaster, impression compound, and zinc-oxide eugenol plaster. Impression waxes include, for example, polysulfides, polyethers, silicones, sodium alginate, and agar. In one aspect of the invention, the impression material may include vinyl polysiloxane putties and may include a layer of putty and a layer of less viscous “light body” impression material in an impression tray. The putty and less viscous light body may be pre-measured for the patient. The inventive kit may include pre-packed impression trays. In some embodiments, a light body wash may be provided.

The kit may include one or more “selfie lights” to ensure still photographs or scans of the patient are well-lit. In some embodiments, a smartphone camera may be used to take a facial scan using facial recognition software, such as bellus3D™ For example, a circular LED light may be used. In some cases, a facial scan may include a scan of the patient's teeth.

In some embodiments, the inventive kit may include materials, instructions, and/or a measurement device operative to measure and record tooth movement, mandibular movement, and/or dental articulation. The interpupillary distance and plane in particular may be measured to establish tooth size and plane. Also face shape for tooth shape and arc of curvature criteria to position a left or right “Frankfurt horizontal” plane of occlusion (a line from the superior aspect of the external auditory canal to the most inferior point of the orbital rim), a curve of Spee (an anterior- posterior curve from the front to the back of the mouth formed by the tips of the cusps of the teeth) and a curve of Wilson (a curve from the right to the left, or across the mouth formed by the tips of the cusps of the teeth). By convention, these curves do not include the six (6) anterior teeth (which normally overlap upon occlusion). So, these curves are defined as beginning at the distal aspect of the cuspid or canine tooth.

The inventive method may include steps of a provider remotely consulting with a patient, the patient collecting data and transmitting the data to the provider, the provider advising the patient on treatment alternatives, and the provider or third party remotely preparing a treatment alternative for the patient (like a lab).

The remote consultation enables a dentist to perform a preclinical assessment to clear the for remote treatment prior to delivery of a dental impression kit. The dentist may include x-ray images, CT scans, or ultrasounds as a source of information in diagnosis and development of a treatment plan.

The method is not limited to any particular means of collecting a dental impression. An impression or scan may be taken in a variety of ways. Regardless of how the impression or scan may be taken, a concierge may guide the patient to be sure that the necessary data is collected correctly. The data may be transmitted directly to the concierge, or a dedicated website may be used to collect the data and/or check the impression.

The method may, in some embodiments, include measuring and recording tooth movement, mandibular movement, and/or dental articulation.

In some embodiments, the kit, device, and process are part of an overall remote and/or in office dental treatment system. The system may utilize the patient's facial landmarks to determine the position of the teeth prior to treatment, both orthodontically and restoratively.

In some embodiments, dental attachments may be produced that attach to a lingual surface of teeth rather than a facial surface. The attachments for aligners attach to the back and front of teeth, whereas restorative products attach to the front. Prior art products, if any, are mostly produced ‘freehand’.

The present invention is suitable for producing aligners as well as restorative designs. Expanded Functions Dental Assistants (EFDA) or hygienists, remotely overseen by dentists, may show the patient what a restorative design would look like before they proceed with treatment. EFDAs may also place composite on teeth for composite veneers and attachments.

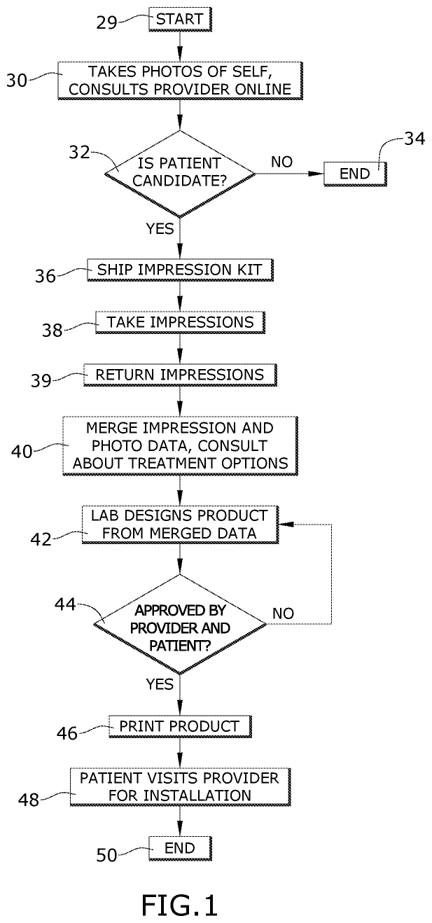

Referring to FIGS. 1-3, FIG. 1 illustrates a process of dental treatment according to an embodiment of the invention. A patient may consult his or her provider online, providing selfies to assist treatment evaluation 30. If the provider determines that the patient is a suitable candidate for remote treatment 32, the patient may order the impression kit 36. If not, the process may be ended 34 or an alternate approach may be selected.

Upon receipt of the kit, the patient may take dental impressions remotely, guided by a concierge 38. The patient may then return the impression to the concierge, provider, or lab 38. The dental impression may be merged electronically with photos or face scan dataset or files provided by the patient. The patient may consult with a doctor and/or the concierge about treatment options 40. The concierge may ensure data collection effective to successfully produce a dental treatment.

Once the doctor, or doctor and concierge, and the patient have agreed on an approach, the concierge may have a design lab digitally design the dental article the patient wants, utilizing dentist supervision and guidance 42. If the patient and doctor approve the design 44, the design may be 3D printed 46. If not, the design lab may provide an alternative design responsive to the patient's and the doctor's comments. Once the design is printed, it may be shipped to the dentist so that the patient may have the design “installed” in the dental office 48.

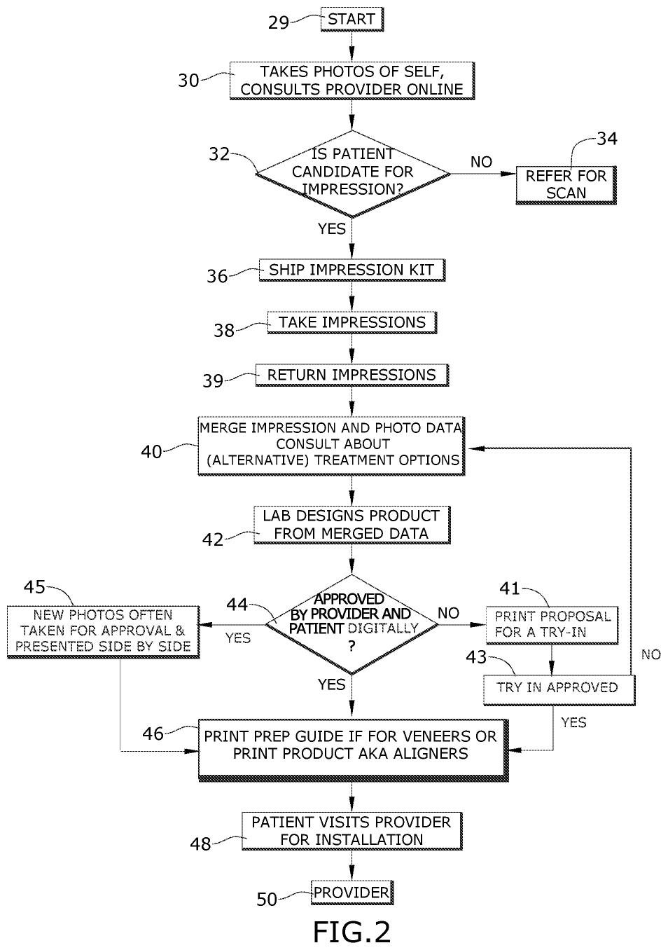

FIG. 2 shows another embodiment of the present invention, wherein if the provider and patient do not approve 44 the lab designs, a proposal for a try-in 41 may be produced. If the try-in is approved 43, the process proceeds as discussed above. If the lab designs are approved 44, new photos may be introduced 45, presented side-by-side with previously obtained images.

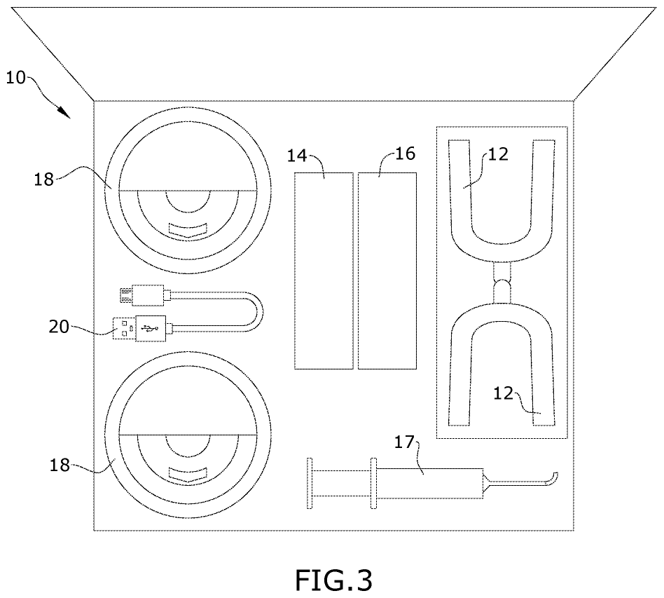

FIG. 3 illustrates components of a kit 10 for collecting impressions according to an embodiment of the invention. The kit 10 may include impression trays 12, vinyl polysiloxane putty 14, light body 16, and a lighting device or “selfie light” 18 with a cord 20.

It should be understood, of course, that the foregoing relates to exemplary embodiments of the invention and that modifications may be made without departing from the spirit and scope of the invention as set forth in the following claims.

What is claimed is:

1. A remote dental impressions kit, comprising: an impression material, one or more impression trays, and an impression transmitting means operative to transmit a patient-produced dental impression to a dental provider.

2. The remote dental impression kit of claim 1, wherein the transmitting means is a physical shipping method or an electronic scanning device.

3. The remote dental impression kit of claim 1, wherein the impression material is selected from the group consisting of: polyvinyl siloxane (PVS) impression materials, impression plaster, impression compound, zinc-oxide eugenol plaster, putty, a light body, polysulfides, polyethers, silicones, sodium alginate, agar, and any combination thereof.

4. The remote dental impression kit of claim 1, further comprising a circular LED light.

5. The remote dental impression kit of claim 1, further comprising a measurement device operative to measure and record tooth movement, mandibular movement, and/or dental articulation.

6. A method of remote initial dental treatment, comprising:
(a) obtaining a still photographic image of a patient remotely from the patient;
(b) determining patient suitability for remote treatment;
(c) providing the kit of claim 1 to the patient;
(d) obtaining the patient-produced dental impression remotely from the patient;
(e) determining a preferred method of treatment from remote communication with the patient; and
(f) obtaining or producing a dental treatment prepared from the patient- produced dental impression.

7. The method of claim 6, further comprising transmitting the still photographic image and/or the remote communication with the patient to a concierge to ensure data collection effective to successfully produce a dental treatment.

8. The method of claim 6, further comprising after providing the kit to the patient, measuring and recording tooth movement, mandibular movement, and/or dental articulation of the patient.

9. The method of claim 6, further comprising merging the patient-produced dental impression electronically with the still photographic image, a CT scan, a radiograph, or a face scan dataset provided by the patient.

10. The method of claim 6, wherein the dental treatment is a dental article, and further comprising designing digitally and printing three-dimensionally the dental article; and
installing the dental article in a dental office.
